(19) United States
(12) Patent Application Publication
(10) Pub. No.: US 2014/0370293 A1
(43) Pub. Date: Dec. 18, 2014

(54) Fine Particles

(71) Applicant: Daniel Robert Johnson, Farnborough (GB)

(72) Inventor: Daniel Robert Johnson, Farnborough (GB)

(73) Assignee: Intrinsiq Materials Limited UK, Farnborough (GB)

(21) Appl. No.: 14/123,598

(22) PCT Filed: May 31, 2012
(86) PCT No.: PCT/GB2012/051228

§ 371 Date: Jul. 25, 2014

(30) Foreign Application Priority Data
Jun. 3, 2011 (GB) 1109319.2

(51) Int. Cl. B23K 10/00; B01J 13/00

(52) U.S. Cl. CPC B23K 10/00; B01J 13/0026
USPC 428/403; 219/69.1; 516/33

(57) ABSTRACT

The invention relates to a process for the preparation of fine particles, the process comprising introducing a susceptor material into a plasma stream thereby vaporising some or all of the susceptor material; cooling the susceptor material downstream from where the susceptor material was introduced, thereby creating particles of the susceptor material; applying energy selected from electromagnetic radiation of wavelength shorter than the optical band gap of the susceptor material, sound waves, photons, or a combination thereof, to the particles; and modifying the density of defects of the particles. Also described is a fine particle comprising a core comprising a susceptor material and a coating comprising functionality selected from hydrogen, methyl, ethyl or combinations thereof, and a C₆-C₂₄ alkyl. A dispersion comprising a dispersed phase and a continuous phase, wherein the dispersed phased comprises a multiplicity of the fine particles.

### FIELD

The invention relates to a process for preparing fine particles, to the fine particles themselves and to dispersions containing these. In particular, the invention relates to processes where the surface of the fine particles has been modified through the application of energy thereto.

### BACKGROUND

A problem often encountered when working with fine particles is their tendency to undergo unwanted surface reactions, such as oxidation, as a result of the generally high surface energy of the particles. These reactions can lead to agglomeration or loss of activity.

In order to protect the nanoparticles from these unwanted chemical reactions and, where desired, to provide additional functionality to the particles, fine particles may be coated. This coating can have the additional benefit of improving dispersion of the particles in secondary media, increasing the range of possible applications for the particles.

Examples of applications of coated particles include ink dispersions, chemical synthesis, biological imaging, diagnostics and drug delivery. In view of this wide range of potential uses, there is an ongoing need to improve the properties of coated fine particles.

One method that has been used to prepare such particles is plasma deposition. These processes subject the gaseous, liquid or solid core material to heating with plasma, resulting in physical or chemical rearrangement of the core material, dispersion and final condensation into fine particles. The fine particles can then be coated using conventional, for instance spray or dip, techniques.

However, such coating systems could be improved. The reaction conditions used often lack selectivity, resulting in either uneven coating of the surface, or in some cases disruption of the particle so that reaction also occurs through the body of the particle. This may occur, for instance, where the coating process is promoted using ionisation reactions. In addition, many methods for coating particles prepared thorough plasma deposition are wasteful of reagents, as the reagents are often forming the coating layer and/or reacting with the particles at temperatures very close to their decomposition points, resulting in decomposition of at least some of the reagent during the coating process. Ionisation reactions and thermal activation reactions in particular, have these disadvantages.

Further, coating may be incomplete as a result of steric hindrance arising from the molecules already deposited as the coating, or where the particles themselves contain low levels of surface defects. Surface defects increase the surface area of the particle, resulting in the presence of highly reactive “dangling” bonds (i.e. atoms with incomplete valency) of core material, which in turn promote reaction with the coating reagent.

Whilst some particle formation techniques, particularly those such as milling which require high levels of physical agitation of the core material, are excellent at producing fine particles with a high level of surface defects, the physical nature of these techniques inevitably leads to contamination of the product, particularly where duty conditions are extreme and where milling occurs over a long period of time.

As such, it would be beneficial to provide an alternative particle formation technique that can introduce surface defects into the particles, but which does not have the problems of contamination.

The degree of crystallinity of the coating can also affect the ability of the particle to accept a full and even coating. It is generally the case that the more defective the particle, the more reactive dangling bonds are present contained within defects. As a result it is more likely that the coating process will occur and, where diffusion is limited, then reaction occurs primarily at a defect site residing at the particle surface, and not through the body of the particle. As such, it is desirable to provide a particle formation process which promotes less crystallinity in the fine particles formed either through chemical, thermal or mechanical means.

One method that has been used for producing coated fine particles is that of the applicant's co-pending application WO 2010/073021. This document describes the formation of particles using thermal plasma processes, followed by in-flight or solution coating with organic molecules such as surfactant molecules. The coating is intended to prevent particulate agglomeration, improving dispersion of the particles in solvent media.

The invention is intended to overcome or ameliorate at least some aspects of the above problems.

### SUMMARY

Accordingly, in a first aspect of the invention there is provided a process for the preparation of fine particles, the process comprising:

introducing a susceptor material into a plasma stream thereby vaporising some or all of the susceptor material;

cooling the susceptor material downstream from where the susceptor material was introduced, thereby creating particles of the susceptor material;

applying energy selected from electromagnetic radiation of wavelength shorter than the optical band gap of the susceptor material, sound waves, photons, or a combination thereof, to the particles; and

modifying the density of defects of the particles.

Accordingly, a key part of the invention is the use of plasma deposition to prepare fine particles. It is believed that the process of the invention can offer improved reaction efficiency, as the surface reactions are more complete yet less energy is required. Further, a lower concentration of a wide variety of organic molecules may be used, yet higher product yields obtained. The process steps described above may be sequential.

The susceptor material is preferably introduced to the plasma stream in particulate form, even nanoparticulate form or as a percursor material such as an organometallics or other metal compounds including hydrides. The smaller the nucleating particles of susceptor material are during plasma treatment, the smaller the resulting fine particles will be, and the smaller the distribution in particle size will be. The particles of susceptor material to be introduced to the plasma stream may be produced using a variety of methods. Examples are ball-milling, deposition from a sol-gel or plasma deposition or separately synthesized and commercially available compounds as gases, liquids or solids.

It will often be the case that the plasma stream will be at a temperature in the range 5000° K-15,000° K, after the susceptor material has been passed through the plasma stream, it will be cooled, so that the susceptor material condenses into particles, typically the susceptor material will be cooled to a temperature in the range, 0-1000° C., often 10-500° C. The cooling is necessary to cause solidification of susceptor particles and to reduce the temperatures following the plasma stream to allow for surface modification of the susceptor material. Specifically, if the surface modifying reagent were to decompose or burn, it would form a compound with the susceptor material. Therefore, the coating must occur downstream of the plasma torch, in a cooler region of the apparatus.

The energy may be applied after the particles of susceptor material have been formed, or during the condensation phase, as appropriate. It may often be the case that the electromagnetic radiation or photons described be applied after the particles have condensed, but that the sound waves be applied during condensation of the particles and/or after their formation.

Surface modification may be achieved using a wide range of techniques, as would be known to the person skilled in the art and which are described in WO 2010/073021, the subject matter of which is herein incorporated by reference in its entirety. For instance, the reagent may be present in gas or liquid form or in solution, and the particles of susceptor material passed through the reagent after formation; alternatively, the reagent may be sprayed or injected onto the newly formed particles in an injection zone which is at a temperature lower than the temperature in the plasma chamber; as a further alternative, in-flight coating of the particles with the reagent may occur.

The fine particles may be collected by filtration, cyclone or liquid methods. However, in the process of the invention, the fine particles will generally be collected into a liquid. Where a liquid is used to collect the particles, it may contain one or a plurality of solvents. The solvents may simply act to collect and disperse the particles or they may act to further modify the surface thereof. In some examples, the deposition of the condensed particles of susceptor material into the liquid may constitute the component parts of a surface modification step.

### Application of Electromagnetic Radiation

Surface modification of fine particles usually requires a source of activation energy and molecules able to react at sites on their surface.

For example, many particles contain defects comprising uncoordinated dangling bonds and when synthesised from, for instance, a hydrogen-based gas, the hydrogen or other competing chemical species can become bonded to these defects. This reaction with hydrogen passivates the surface and is preferable to oxygen passivation because it dissociates under more moderate conditions owing to the lower bond energy.

The application of electromagnetic radiation has the benefit of improving the selectivity of the surface modification reaction. It is known that ionisation of reagents, such as organic molecules, to provide free radicals may occur in plasma streams; this ionisation forms the basis of mass spectroscopy. However, ionisation reactions are intrinsically non-selective and wasteful of reagent molecules as these often become thermally activated and decompose. The electromagnetic radiation applied in the invention is of lower energy and so does not ionise the particle surfaces or reagents, but when incident upon the fine particles it is absorbed, creating particle heating and subsequent thermally induced reaction at its surface. The selection of the wavelength of the electromagnetic radiation is important, as it is this that ensures that reaction is at the surface of the particle and not throughout the volume of the reagent.

As used herein the term “reagent” refers to materials with which it is intended to coat the particle, whether through physical interaction or chemical reaction with the susceptor material, as such, the term “reactant” could equally be used in this application, as the term “reagent” used herein is not intended to encompass components of the system simply present to cause the reaction, or to observe the reaction, but the coating materials themselves.

The particles of the invention are formed from susceptor materials. As used herein, the term “susceptor” is intended to refer to any material which can absorb energy and convert this to heat. Such materials include, for instance, silicon and germanium.

Without being bound by theory, it is believed that incident electromagnetic radiation having energies greater than (and hence wavelengths shorter than) the optical band gap of the susceptor material will cause heating in that material. For example, silicon has a band gap of 1.1 eV and so substantially absorbs electromagnetic radiation with energy of greater than this value (for instance 1.12 eV) or wavelengths of less than 1107 nm. In most examples of the invention, the electromagnetic radiation is of wavelength in the range 405-5000 nm, often 425-2500 nm, in many cases 450-1250 nm.

Thus, by controlling the wavelength of the electromagnetic radiation, a source of electromagnetic radiation can be used to specifically heat the susceptor material and not its surroundings. As the temperature of the space surrounding the material is not changed, the particle as a whole is not heated, and rearrangement/disruption of the particle does not occur. In addition, unreacted reagent does not decompose, as it is not subjected to heating. It is possible to selectively heat the particles, as it is primarily the particle that interacts with the electromagnetic radiation, and coating is thus facilitated at the surface of the heated particles.

As used herein the term “coating” is intended to refer to complete or partial covering of a particle core. The coating may be adhered to the susceptor material through physical interaction (for instance Van der Waals forces) or through chemical bonding (direct or indirect) to the susceptor material. Whilst the coating may be partial, the coating is most effective where it substantially covers the core. In preferred examples the surface of the core is covered by the coating.

The coating may substantially be a monolayer, a monolayer with areas of bilayer and/or trilayer or of multiple layers. By “layer” is meant a distinct area of coating one molecule thick, in a monolayer the molecules may be aligned substantially parallel to the surface of the core, or perpendicular, or at an angle in between. It will often be the case that the layer will be formed of molecules aligned substantially perpendicular to the surface of the core, such layers are often said to be of “forest” construction. It will generally be the case that the coating will be substantially monomolecular comprising a single molecular composition or a multiplicity of molecules of differing composition, the use of monolayer coatings reduces the amount of coating material required.

The average thickness of the coating is likely to be in the region of 0.1-100 nm per layer, often the thickness of the coating layer will be in the region of 1-50 nm where there is a monolayer and 2-100 nm where the coating is a bilayer.

When referring to the process of coating, this term may be used interchangeably with references to “surface modification” and the like.

For reactions which require thermal activation, the coating process of the invention can be very specific for surface interaction, and makes efficient use of the reagent available. Further, as non-reacted reagent is not subjected to extremes of heat, it is not decomposed or modified in other ways and can be collected for reuse.

Further, in some examples, the electromagnetic radiation can be applied at one or more discreet wavelengths (be this a narrow range of wavelengths or a specific wavelength within experimental tolerances). In such cases the electromagnetic radiation is used to excite specific vibrational modes of the reagent and/or the susceptor material. By activating specific functionalities within the reacting materials, very specific reactions at the particle surface can be promoted, providing a selectivity not previously seen. The skilled person, familiar with the principles of spectroscopy, would be capable of selecting an appropriate wavelength for the promotion of a particular reaction.

As the skilled reader will appreciate, if the electromagnetic radiation is being applied to the susceptor material and reagent to promote coating at the surface of the fine particle, the particle of susceptor material will generally be required to have condensed from the plasma, so that it may provide a defined surface for reaction.

It should be noted that whilst this phenomena has been described with reference to radiation and wavelengths, due to the wave-particle nature of electromagnetic radiation, a description could have been provided in terms of photonic bombardment and specific energies of the photons.

### Application of Sound Waves

Energy in the form of sound waves may also be applied to the particles. This can help to induce the formation of surface defects in the susceptor material, promoting functionalisation.

Conventional processes for preparing fine particles, such as milling processes, produce particles that have high levels of surface defects, which as a result are highly reactive, due to (it is believed) the presence of a high number of “dangling” bonds at the surface of the particle. However, such methods are prone to contamination, cannot offer particles of a uniform size or shape, and are therefore undesirable for some applications.

The applicant has discovered that by subjecting a plasma formed fine particle to high energy stress/strain it is possible to leave the particle size substantially unaltered, retaining uniformity of particle size, whilst producing particles with more surface defects. Subsequent surface modification results in a denser coating, improving passivation and stability to oxidation/corrosion. Further, where the particle is being functionalised, improved functionality per fine particle is provided. This stress/strain can be provided using sound waves, in particular ultrasound waves. These may be in the range 15 kHz-100 kHz, often 20 kHz-80 kHz.

The ultrasonic energy could occur with particles in-flight during the plasma synthesis, for example, ultrasonic energy impinging on particles both whilst condensing or once fully condensed from the plasma vaporised material could be used to cause this microstructural damage.

### Application of Photons

Additionally or alternatively, photonic energy could be applied to the fine particles. This also has the potential to introduce surface defects into the particles, increasing their reactivity as described above.

In some examples, the photonic energy will be highly collimated, for instance, laser light. The frequency of the laser light will often be in the range 190-2500 nm or narrower.

Often, the laser energy will be applied continuously, for the duration of the application. However, the laser energy may also be pulsed on and off during the duration of the application. For instance, condensed particles could be passed through the path of a femtosecond laser, this would create a rapid cycle of melt/freeze or heat/cool in the particles resulting in rapid increase in work hardening. As noted above, it is also possible to use the laser as described above in terms of electromagnetic radiation, so that in addition to the function of increasing surface defects, the laser, or other photon source, may also be used to heat the surface of the susceptor particles.

Due to the coherency of laser light, it may often be desirable to use a laser where a very specific wavelength of light is required, for instance to activate a specific chemical reaction as described above.

### Susceptor Material

In the inventive process the susceptor material may be any susceptor material which can be processed using plasma techniques. The susceptor material may be a metalloid. Often the susceptor material will be selected from silicon; germanium; selenium; arsenic; antimony; tellurium; indium; gallium; aluminium; zinc; cadmium; lead; chalcogenides, phosphides or nitrides of the above; inorganic nano phosphors; quantum dots; and combinations thereof. Examples of inorganic nano phosphors include cerium doped yttrium aluminium garnet. Often where quantum dots are used, these will be of size in the range 1-10 nm. In some examples it will be selected from silicon, germanium and compounds thereof, often silicon or silicon compounds, most often silicon per se. Other compounds using differing metal chalcogenides are known for this purpose.

### Surface Modification

The surface modification of the inventive process may be to passivate the fine particles or to introduce additional functionality. Modification can change the physical and chemical properties of the particle surface, protecting the core material and making it possible to provide, for instance, particles with reduced agglomeration, increased bioavailability or tuneable emission wavelengths.

As used herein the terms “core material” and “susceptor material” are intended to be used interchangeably.

The surface modification often acts as a coating for the core material, this coating physically protects the core, and may also act as a gas barrier, retarding or preventing oxidation and/or corrosion of the core. It has been found with elemental cores, such as metal cores, that the presence of the coating reduces the rate of oxidation to below 10%, possibly below 5% of that observed where the coating is absent. The coating may temporarily reduce surface energy by reducing the driving force for the surface to react with air and the like. Polar oxygen ions or oxygen may be, for example, kept at a distance by the polar coating.

In the process of the invention, the surface of the particles will often be modified by hydrogen termination. Hydrogen termination stabilises/pas sivates the particles improving their dispersion properties. However, hydrogen termination also has the advantage that it can stabilise the particles, preventing oxidation for instance, or reaction with water (leading to corrosion), prior to further reaction to functionalise the surface of the particles, for instance with organic molecules. However, the stability imparted by hydrogen termination of nanoparticles can be limited and so oxidation and corrosion can occur over time, hence the preference for organic molecules to improve stability.

As such, in the process of the invention, the surface of the particles will often be modified by carbon-bond formation or oxygen-bond formation with the susceptor material. This may be by direct reaction between a surface atom of the susceptor material and a reagent, or by displacement of a terminal hydrogen by a reagent or a combination thereof.

In many instances, the reagent is selected from an alkane, alkene, alkyne or combinations thereof. The reagent may contain additional reactive groups, and these may react with the susceptor material, or (whether or not additional reactive groups are present), reaction may be carbon-bond formation with the susceptor material. In cases where carbon-bond formation is desired, yet the reagent contains a functional group that may react in preference to the carbon functionality, it is possible to specifically excite the carbon bond, as described above, promoting reaction at this site, in preference to others.

Typical alkanes include C₁ and C₂ alkanes, so that a methyl or ethyl functionality may be added to the surface of the susceptor material. Often, the alkene or alkyne includes a C₅-C₂₀ alkyl chain, often this will be a C₆-C₁₈ alkyl chain, in some cases a C₈-C₁₆ alkyl chain or a C₁₀-C₁₄ alkyl chain.

The reagent will often contain one or more functional groups selected from halogeno, amine, amino, siloxane, carboxyl, alcohols, aldehyde, ketone, esters or methyl. Where the reagent is an alkene or alkyne, it is often the case that the unsaturated carbon bonds be present on the terminal carbon atom, as this facilitates reaction with the surface of the particle. Where functional groups are present in addition to the alkene or alkyne, it can be advantageous if the unsaturated carbon bond is at the opposite end of the molecule to the other functional groups, in a head-and-tail arrangement. This places the functional groups other than the alkene/alkyne at the outer surface of the monolayer or bilayer of the particle, allowing control of the surface properties of the fine particle, in particular, allowing control of the dispersive properties of the particle. For instance, creating a particle with a polar or charged surface would increase repulsion between like particles, and promote dispersion in polar solvents. In addition, polar organic molecules easily form monolayers, this tendency can facilitate the production of a uniform coating on the surface of the susceptor material.

Surface functionalisation of the susceptor material with organic molecules often employs hydrogen terminated surfaces and unsaturated organic reagents. The reaction involves the formation of a surface-carbon bond at hydrogen terminated surface sites. Energy is required to activate the reaction, this may be to break the bond between the susceptor material and the terminal hydrogen (typically a homolysis reaction), to ionise the reagent so that a free radical is formed, or a combination of the two. The reaction may be promoted using thermal, plasma or UV ionisation or catalytic activation of the organic species.

Where the susceptor material is silicon, the unbound hydrogen from the silicon surface adds to the unsaturated carbon-carbon bond of an alkene or alkyne in an anti-Markovnikov addition. Where the unsaturated C—C of the molecule is triple bonded, then it becomes double bonded from hydrogen addition through hydrosilation, following the same addition rule.

However, the presence of hydrogen is not a prerequisite to the formation of susceptor material-carbon bonds, as the dangling bonds arising from surface defects in the particle will also facilitate the reaction.

Often the reagent will be selected from an alkane and at least one of an alkene or alkyne. This helps to provide a more complete surface coverage of the particle than has previously been possible. In particular, where the alkane is a short chain alkane, such as a C₁ or C₂ alkane, these can occupy the space between larger, more sterically hindered groups, preventing the oxidation or corrosion at the surface of the particle which could otherwise occur.

For instance, the applicant has found that fine particles formed through plasma deposition (whether in the presence or absence of hydrogen), will only become partially occupied when functionalising with long chain organic molecules including alkynes, alkenes and to a lesser extent alkanes.

Without being bound by theory, it is believed that the partial coating arises as a result of steric hindrance between adjacent alkyl chains, leaving unreacted or hydrogen terminated sites on the susceptor material surface in the interstice. For systems where the susceptor material is silicon, the maximum functionalisation with long chain organic molecules can be calculated as 30-45% of the surface area. This is because the surface packing of silicon (0.38 nm) is smaller than the cross-section of an alkyl chain (0.42 nm).

The remaining hydride terminated or dangling bond-containing susceptor material surface is therefore available for reaction with other species, such as water or oxygen, which are small enough to occupy the interstices between the long chain organic molecules. This is undesirable as these small molecules may alter the reactivity of the particle, reducing its suitability for the intended use. In addition, once the reaction with these small molecules has occurred, it may be difficult to remove this unintended functionality due to the strength of the bonds formed.

However, reaction of the susceptor material with short chain alkanes, so that ethyl, or more often methyl, functionalities are found in the insterstices between the long chain alkyl groups, prevents these secondary reactions from occurring, providing a more complete passivation than previously possible. In particular, as these short chain alkyl moieties are substantially inert, they do not hinder the activity of the long chain molecules, simply providing a physical barrier to reaction of the susceptor material surface with other molecules, and ensuring that the coating is as complete as possible. Further, although particles entirely coated with short chain alkanes would have a tendency to agglomerate due to the dominance of Van der Waals attractions between particles, the presence of the long alkyl chains prevents this, providing particles that have excellent dispersion properties.

The surface modified fine particle may therefore include a plurality of short and long chain molecules in a ratio 99:1 to 55:45, or 80:20 to 60:40 respectively.

This combination of short and long chain moieties covering the surface of the susceptor material may be achieved through a single reaction wherein the cooled particles of susceptor material are mixed with both reagents and wherein functionalisation with each moiety occurs substantially simultaneously, in that the reaction is a “one-step” reaction to the observer. Alternatively, the susceptor material may first be functionalised with long chain molecules, with the addition of the short chain moieties constituting a separate discrete reaction step. Where this is the case the first and second reactions may be carried out in the same way or using different methods, for instance, the long chain reagent could be supplied to the particles in-flight, with the short chain reagent being supplied subsequently, for instance by passing the part coated particles through a liquid containing the reagent.

In an alternative example, the short chain reagent could be injected into a solution of susceptor particles and the long chain organic molecules, and allowed to percolate to the interstices between the bonded molecules and react with the residual hydrogen terminated groups or dangling bonds.

As such, one advantage of the invention is the ability to functionalise the surface of a particle of susceptor material with organic molecules wherein the carbon chains include a sufficient number of carbon atoms to minimise the Van der Waals attraction with other particles treated in the same way.

A further advantage of the invention is the ability to functionalise an increased and preferably a substantial proportion of a fine particle surface with a plurality of organic molecules.

Both these advantages can be achieved by functionalising the surface of a particle with a combination of short chain alkanes and long chain organic molecules, in particular with long chain organic molecules which have alkene or alkyne reactive centres.

### Process of Surface Modification

In the process of the invention it is desirable for the surface modification reaction to occur at a rate in the range 0.1 second to 100 minutes depending upon the degree of thermal or photonic activation and the surface state of the article or reagent. Often this will be in the range 10 seconds to 50 minutes or 1-10 minutes.

As noted above, surface modification may be achieved with the reagent present in gas or liquid form or in solution, so that the particles of susceptor material are passed through the liquid after formation. Alternatively, the reagent may be sprayed or injected onto the newly formed particles in an injection zone which is at a temperature lower than the temperature in the plasma chamber; as a further alternative, in-flight coating of the particles with the reagent may occur.

In embodiments of the invention where the susceptor material is coated using a liquid reagent, the reagent may be a material which is in liquid form at the coating temperature, or a solution containing dissolved reagent. As used herein, the terms “liquid” and “solution” are to be given their ordinary meaning in the art. When being described in general terms, the liquid reagent and the solution of reagent will be referred to as a “liquid medium”. The medium may comprise a mixture of different chemicals, which may each be in solution or a liquid form (often a substantially pure liquid form) of a compound. Often the liquid comprises an organic reagent without any dissolved solids, often the liquid is “neat”.

Where the liquid medium is a solution, the reagent will often be present in the range 0.5-10 w/w, often 3-7 w/w, in some cases around 5 w/w. The solution may be heated, to improve solubility, to reduce the time delay required between formation of the particles and the coating step and/or to reduce the cooling effect on the gas stream. Temperatures in the range 50-90° C. may be used, often 50-70° C., in some cases a temperature of around 60° C. (so in the range 55-65° C.) may be used.

In many examples, the solvent will be selected from water, water miscible solvents, and organic solvents. Often the solvent will be selected from water, alcohols, aromatic hydrophobic solvents and combinations thereof, in some examples the solvent is selected from water, ethanol, iso-propanol, toluene and combinations thereof. In some examples the solvent will be selected from water, ethanol, dichloromethane, hexane, cyclohexane, dimethylformamide or combinations thereof.

Particles of the core material are carried to the liquid medium in a gas stream and bubbled through the medium. It will be preferred for safety reasons that the gas is an inert gas such as a noble gas or nitrogen. Often argon will be used as the carrier gas because of its ready availability.

The liquid medium will generally be housed in a “liquid trap” such as would be known to the person skilled in the art. In such traps the carrier gas is released into the liquid medium below the surface of the liquid, and bubbles up through the coating solution or liquid coating material to be released at the surface. During the transit of the carrier gas through the liquid medium, the particles of core material are believed to be released from the gas, coated, and retained in the liquid medium. It can be useful to ensure that the gas is at a pressure above atmospheric pressure at the point of entry to the coating chamber, in this way the bubbling process can be facilitated.

The fine particles of the invention may be recovered from the liquid medium using any conventional means such as filtration, solvent evaporation, magnetic separation centrifugation etc. as appropriate. The resulting product is a free-flowing powder of fine particles.

This method has the advantage of removing the possibility that the surface modified particles may be gathered on a filter, perhaps sintering during the gathering process; instead the surface modified/coated particles are collected from the liquid medium. In addition, solution coating of the susceptor material can provide for a greater control of the modification temperature and coating medium than “in-flight” methods where there is a risk that the reagent can be degraded if fed into a zone of the plasma flow-line which is too hot.

However, in-flight methods may be used, and in such cases it will often be the case that the reagent will be carried into the plasma apparatus in a gas stream, the gas acts as a carrier for the reagent allowing it to be contacted with the particles of the susceptor material in aerosol or vaporised form. The finer the spray of reagent, the more efficient and controllable the coating process and accordingly it is preferred that the reagent be carried either as a fine aerosol or in vaporised form. Vaporised form is preferred as interaction between different molecules of the reagent is at its minimum in this form.

It will be preferred for safety reasons that the gas is an inert gas such as a noble gas or nitrogen. Often argon will be used as the carrier gas because of its ready availability. Where the reagent is gaseous at room temperature then it may be added to the inert gas stream at a concentration selected to allow controlled in-flight reaction of particle surfaces. A gaseous reagent may be used in combination with liquid or vapourised reagents from a liquid medium as hereinbefore described.

In many examples the inert gas stream is sprayed upwards towards the plasma torch, but does not contact the plasma torch. This is achieved by positioning the gas stream to bring the reagent into contact with the fine particles of susceptor material at the highest possible temperature and as soon as possible after formation of the particles. In some examples the coating material is heated prior to injection. Heating the coating material reduces viscosity facilitating conversion into a fine spray.

Subsequent to coating the fine particles are recovered using organic solvents, which are then evaporated from the particles. The resulting product is a free-flowing powder of fine particles of the invention.

### Fine Particles

In a second aspect of the invention there is provided a fine particle comprising:

a core comprising a susceptor material; and

a coating comprising functionality selected from hydrogen, methyl, ethyl, or combinations thereof; and a C₆-C₂₄ alkyl.

By fine particles is meant particles having a size of less than a micron and generally in the order of 100 μm or less. Preferably the fine particles are nanoparticles, by nanoparticles is meant particles having nanometric dimensions, and nanoparticles may have, for example, dimensions in the order of a few nanometres to several hundred nanometres. Nanoparticles may be spherical or aspherical, and may also be known as a nanopowder or as a nanometric material. Advantageously, the fine particles lie in the size range 1 to 200 nm, more preferably in the range 5 to 100 nm, further preferably in the range 10 to 50 nm, and often in the range 10 to 20 nm.

In some examples the fine particle will be spherical. The fine particles of the invention, when made using a thermal plasma process such as that described in this application, are spherical to within the limits of detection. For instance, under SEM/TEM analysis the particles appear spherical. Without being bound by theory this is believed to be due to the enormous force exerted by the surface tension of the molten core material which, because of the tiny dimensions involved, has a very high surface to volume ratio.

A fine particle according to the invention will preferably include a susceptor material that is a high surface energy material, such as those described above.

It is generally desired that the coating substantially cover the core. Often the coating will be chemically bonded to the core as described herein.

### Dispersions

In a third aspect of the invention there is provided a dispersion comprising a dispersed phase and a continuous phase, wherein the dispersed phase comprises a multiplicity of fine particles according to the second aspect of the invention.

Typical dispersion concentrations will be in the range 0.001-50 wt %, often in the range 0.01-25 wt %, in some examples in the range 0.5-15 wt % or 0.5-10 wt % of fine particles.

The continuous phase may be any fluid in which the fine particles are insoluble, the fluid will typically be a liquid at ambient temperature and the liquid will typically be non-toxic, and of low boiling point, such as a boiling point less than 250° C. The fluid will often be an organic solvent or water. Often the continuous phase will be selected from hexane, toluene, cyclohexane, 2-propanol, ethanol, butanol, ethylene glycol, diethylene glycol, butyl ether or combinations thereof.

Unless otherwise stated each of the integers described in the invention may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims.

Further, in the discussion of the invention, unless stated to the contrary, the disclosure of alternative values for the upper or lower limit of the permitted range of a parameter, is to be construed as an implied statement that each intermediate value of said parameter, lying between the smaller and greater of the alternatives, is itself also disclosed as a possible value for the parameter.

In addition, unless otherwise stated, all numerical values appearing in this application are to be understood as being modified by the term “about”.

### BRIEF DESCRIPTION OF THE DRAWINGS

In order that the present invention may be more readily understood, it will be described further with reference to the figures and to the specific examples hereinafter.

FIG. 1 is a schematic diagram of a nanoparticle functionalised with long chain alkyls;

FIG. 2 is a schematic diagram of a nanoparticle functionalised with both long and short chain alkyls;

FIG. 3 is a schematic diagram of the apparatus used in the process of the invention;

FIG. 4 is a is a side elevation of an embodiment of the apparatus attached to a known plasma torch;

FIG. 5 is a schematic diagram of the apparatus used in the process of the invention;

FIG. 6 is a schematic side elevation of a coating chamber;

FIG. 7 is a schematic side elevation of an injection zone;

FIG. 8 is side elevation of a pressurising and heating unit for the coating material; and

FIG. 9 is a schematic side elevation of a coating material atomiser.

### DETAILED DESCRIPTION

### Fine Particles

The second aspect of the invention relates to fine particles with a susceptor material core and a coating. In this specific example, the core is a silicon core and the coating a 55:45 combination of methyl moieties derived from C₁ and C₂ molecules and C₆ to C₁₂ alkyl chains derived from hexene to 1-dodecene (i.e. C₆, C₇, C₈, C₉, C₁₀, C₁₁ or C₁₂ alkyl chains).

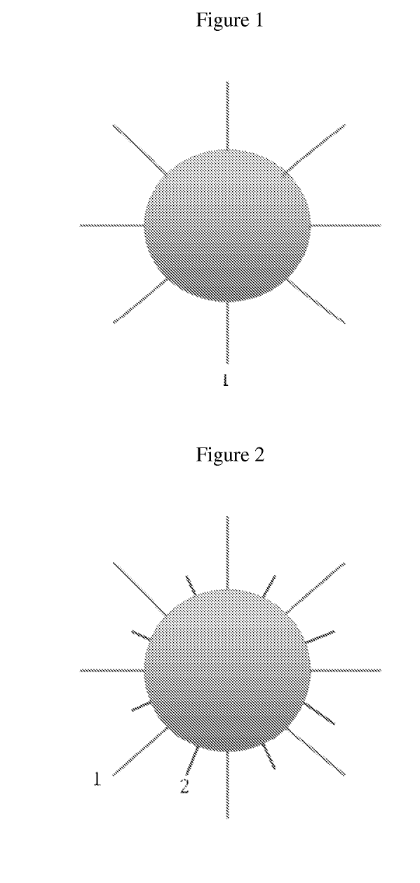

The nanoparticle of FIG. 1 contains only hexene molecules 1, and is prone to further unwanted reactions in the interstice between these. In FIG. 2, the interstice between the long chain molecules 1 has been functionalised with methyl moieties 2.

### Apparatus

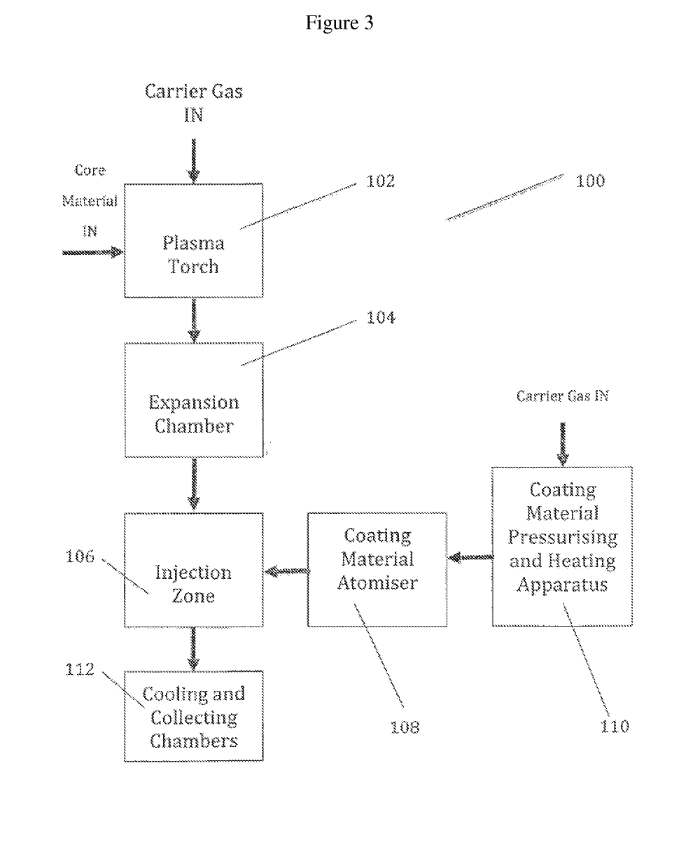

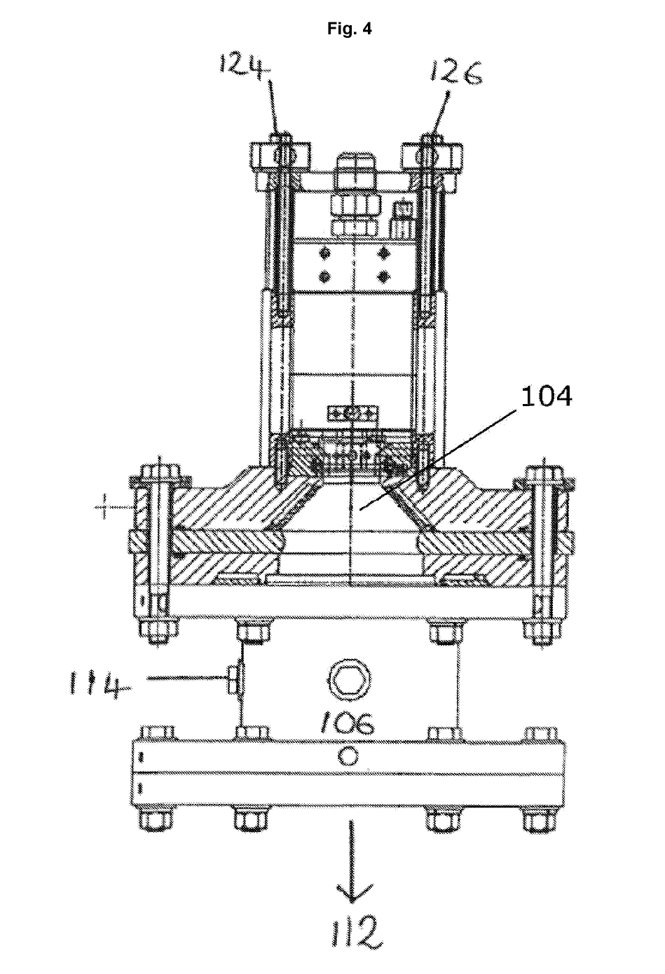

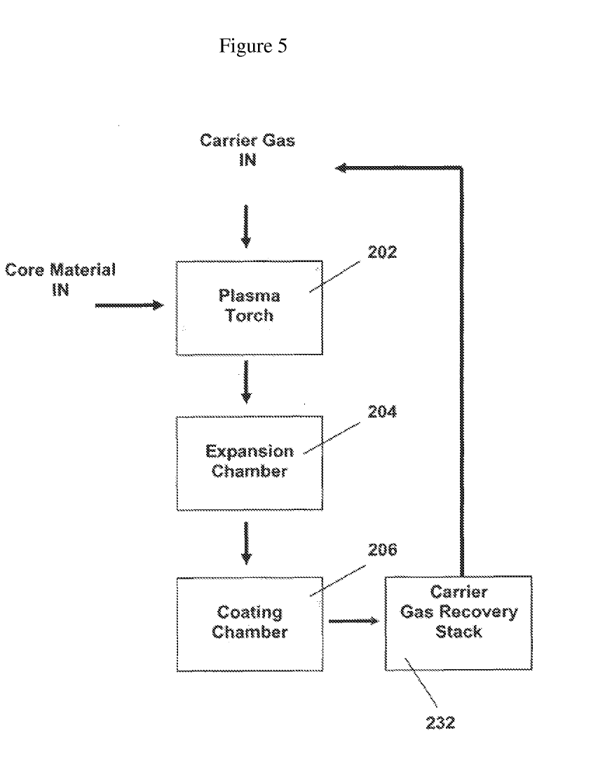

A modified thermal plasma apparatus 100 was used to generate fine particles in accordance with the invention. Representations of the apparatus 100 are shown in FIGS. 3, 4 and 5.

A plasma torch 102, 202 is positioned adjacent an inlet channel (not shown) and silicon powder injected via the inlet channel into a plasma stream from the plasma torch 102, 202. The torch 102, 202 is connected to an expansion chamber 104, 204 which allows the silicon to expand and cool. The particles of susceptor material, in this example silicon, are formed in the expansion chamber 104, 204. In the first example the particles flow from the expansion chamber 104, 204 to the injection zone 106, which includes an injection point 114. The coating material, in this example a mixture of hexene and methyl groups in a 50:50 mol % ratio is supplied to the injection zone 106 from a coating material pressurising and heating apparatus (a fluidising apparatus) 110, via an atomiser. In this embodiment there are three injection points 114 (two only shown, the third injection point is to the rear of the apparatus). The fine particles then pass from the injection zone 106 to the cooling and collection chambers 112.

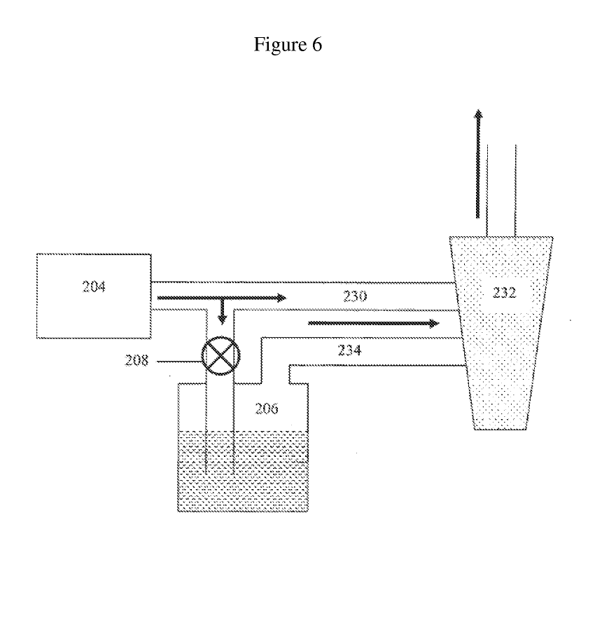

In the second example the particles flow from the expansion chamber 104, 204 to the coating chamber 206 which includes a control valve 228 and bypass conduit 230 (FIG. 6). The coating material, in this example a mixture of hexene and methyl groups in 50:50 mol % ratio, the hexene is supplied in a hexene solution in the coating chamber 206 at a concentration of 5% w/w, or in undiluted liquid form, and the methyl groups in a gas stream of argon at 5% w/w. The fine particles are then retrieved and stored in collection chamber 112.

The plasma torch 102, 202 in the preferred embodiment is a known DC non-transferred arc torch. Other plasma torches or plasma spray torches may also be used. Gas, in this example a mixture of argon and helium, is passed between a cathode 124 and anode 126 where it is ionised and is turned into a plasma. In this embodiment the torch power is 30 kW and the flow rate of the argon/helium gas mixture is 72 litres/minute for the argon and 9 litres/minute for the helium. In further embodiments the argon gas contains up to 30% helium by volume, and/or hydrogen and/or a hydrocarbon gas such as methane or mixtures of these gases may also be used.

Preferably the plasma torch 102, 202 has a flow stabilisation means, such as a vortex flow stabiliser (not shown) to help define the path of the plasma stream. The plasma torch 102, 202 may also comprise a known powder feed system that is enabled to directly feed powdered material into the gas flow or into the arc of current that is created between the cathode 124 and anode 126. In the preferred embodiment the copper core material is fed into the plasma torch at a rate of 100 g/h and the rate of argon gas flow is approximately 50 to 80 l/min.

The expansion chamber 104, 204 of this example is frusto-conical. The expansion chamber 104, 204 must be cooled as this chamber 104, 204 is exposed to very high temperature plasmas. This begins the particle cooling process in which a temperature gradient is observed, the hottest region being the expansion chamber 104, 204, the coolest being the cooling chamber 112 and, where present, the injection zone 106 is positioned in between. It is the combination of expansion and cooling which allows the particles of silicon to form.

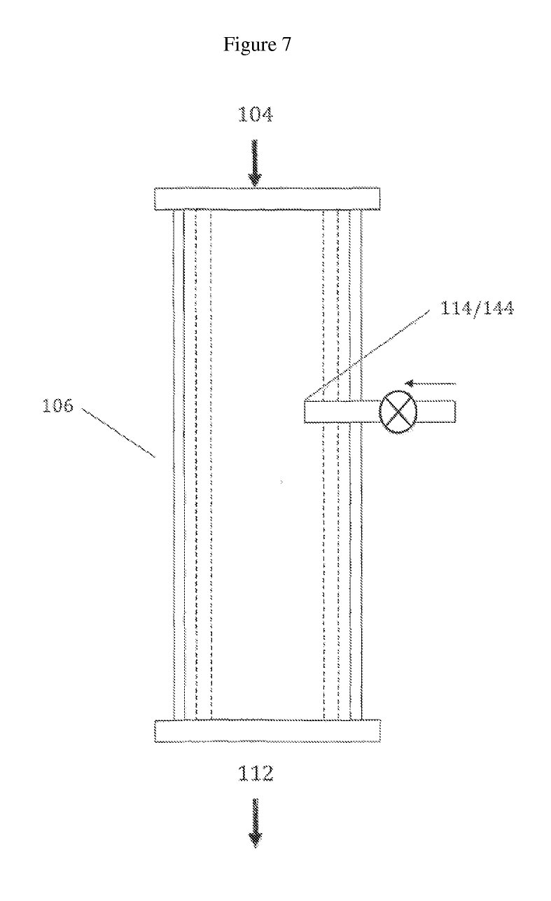

In some embodiments the silicon particles then flow into the injection zone 106, where they are coated (FIG. 7). The injection zone 106 is cooled, in this example using a water jacket (not shown) including water circulating at a rate of 45 litres/minute. Thus a temperature gradient is created in the injection zone 106, the highest temperature region being adjacent to the expansion chamber 104.

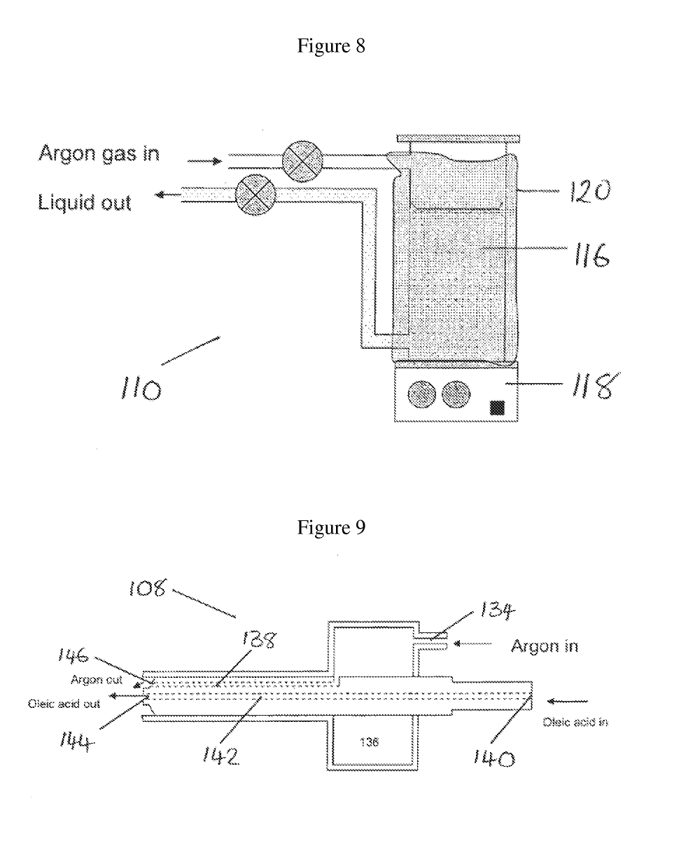

In these embodiments the reagent is prepared for injection into this zone 106 in a pressurising and heating apparatus (FIG. 8). In this embodiment the apparatus comprises a stirred reservoir 120 of reagent which is heated up to 250° C. and pressurised up to 4 bar (400 kPa). Where alternative coating materials are used, the skilled person would know to use alternative temperatures and pressures as necessary in order to reduce the viscosity of the reagent, but (in examples such as this) maintain this in liquid form prior to transfer to the atomiser. In this example the reagent is stored under an inert argon atmosphere. The pressurising and heating apparatus 110 is stirred using a conventional heating and stirring plate 118. The temperature in the reservoir 120 is also controlled by the presence of an insulating jacket 116.

The reagent is transferred from the pressurising and heating apparatus to the atomiser 108 (FIG. 9). The atomiser 108 comprises a gas reservoir 136, in this embodiment the gas is argon. The heated reagent is pumped through the atomiser 108, out of the stainless steel nozzle 144 where it is atomised upon mixing with the argon carrier gas. The feed rate of the oleic acid in this embodiment is 605 ml/h.

In this embodiment argon enters the atomiser via a carrier gas inlet 134 and is stored in the gas reservoir 136 prior to mixing with the oleic acid. The reagent enters the atomiser via the coating material inlet 140 from the pressurising and heating apparatus 110. The organic fluid passes through the atomiser via passage 142 to the nozzle 144. The argon exits the gas reservoir through a different exit point 146 in the nozzle 144 at which point it atomises the reagent.

The stream of reagent/argon is injected at an injection point 114 where the temperature is in the range 400° C.-700° C., injection is at the point about 5° C. lower than the decomposition point of reagent. Injection occurs at about 5 milliseconds of silicon particle formation. The stream of reagent/argon does not contact plasma torch 102.

The fine particles of silicon coated with methyl and hexane groups then pass through the injection zone 106, into the cooling and collection chambers 112. The resulting product is a fine powder of unsintered, un-agglomerated particles.

In embodiments where the reagent is liquid, the silicon particles then flow into the coating chamber 206 where they are bubbled through the coating solution at a rate of 50 litres/minute (the main flow is typically 1,500 to 2,000 litres/minute) and at a pressure of 100 millibar gauge overpressure. Flow rate is controlled using control valve 228, excess gas and core material being diverted directly to a gas recovery stack 232 via bypass conduit 230. Bypass conduit 230 also functions to allow pressure relief in the event that the route to the coating chamber 206 becomes blocked.

The fine particles of silicon coated with methyl and hexane groups are then collected using filtration, washed with water to ensure that all of the non-adhered coating material is removed from the coated particles and dried using conventional techniques. The resulting product is a fine powder.

In some embodiments, bypass conduit 230 will be absent, and the whole gas stream carrying the particles may only flow via the coating chamber 206.

Those skilled in the art will understand that the rates of coolant, bubbling, particle and gas flow may be scaled to increase or decrease the yield to be obtained, without departing from the scope of the invention. Further, in embodiments where the core and coating materials are other than as described above, the various flow rates described above may be changed as appropriate for the substrates being used; as would be understood by the person skilled in the art.

### EXAMPLES

### Prophetic Example 1

Sample A is taken from batches of nanosilicon powder produced from high temperature DC plasma and deposited using a silane feedstock. The resulting nanoparticles in the range 5 to 50 nm are substantially crystalline as determined by x-ray diffraction and transmission electron microscopy. Their surfaces are hydrogen passivated with hydrogen supplied from silane decomposition products. The presence of surface silane is determined using infrared absorption measurements using an ATI Mattson Genesis Series FTIR with ATR golden gate stage.

The sample is placed into a solution of dodecene and stirred. It remains for 1 hour at room temperature, is then filtered and dried out and subjected to FTIR analysis where it shows a nominal amount of functionalisation, denoted by weak absorption in FTIR from CHx stretching modes. This suggests that the process of hydrosilation requires a source of activation energy to initiate and drive the process. A second sample of the powder is stirred in dodecene liquid and subjected to exposure from a 100 mW, 473 nm commercial laser. The scattered blue light occurring throughout the mixture is used to irradiate the sample for 1 minute. The amount of heating is within 25° C. during these periods. The sample of nanosilicon when filtered and dried is found to have been substantially functionalised with the organic species denoted by a substantial absorption in FTIR from CHx stretching modes. A solution of dodecene is subjected to 1 minute irradiation by the same said laser and no noticeable temperature increase is observed.

In order to multifunctionalise the surface of nanosilicon, sample A is subjected to dodecene immersion for 1 hour at 80° C. Following this FTIR is performed and shows both the dodecene CHx absorption peaks and those of unfunctionalised surface denoted by residual silane absorption species.

Three further samples of sample A are subjected to:
1. A mixture of dodecene contained in an acetylene atmosphere heated to 80° C. for 1 hour.
2. Immersion into dodecene at 80° C. for 1 hour followed by exposure to an acetylene atmosphere at 80° C. for a further hour.
3. Exposure to an acetylene atmosphere for 1 hour at 80° C. followed by immersion for 1 hour in a dodecene solution at 80° C.

All three samples show a substantial reduction in the silane absorption peaks in FTIR indicating a significant improvement in the functionalisation of the silicon particle surfaces with organic species. The improvement is aimed at removing a substantial proportion of the metastable hydrogen terminated surface found separately to be a source of long-term hydrogen dissociation resulting in an oxidised silicon surface. Heating the resulting powdered samples from preparation routes 1 to 3 at 300° C. it is possible to observe vaporised mass fractions in a residual gas analyser with a mass spectrometer and this demonstrates the various ratios of the two component organic species dependent on the method and ratio of organic species used.

### Prophetic Example 2

Sample B is taken from batches of nanosilicon powder produced from high temperature plasma deposition using a micronized silicon powder feedstock. All characteristics are similar to those in sample A, except that hydrogen is absent from the source and hence no hydrogen is bonded to the silicon surface.

Sample B is subjected to high pressure milling for 1 hour in a solution of dodecene. FTIR analysis of the sample shows a strong peak from the dodecene functionalised to the nanosilicon compared to the standard sample without milling. The magnitude of this change is denoted by the ratio of the CHx stretching peaks around 2900 cm⁻¹ between the two samples.

Taking sample B and subjecting it to 20 nanosecond pulses from a lambda physik excimer laser operating at 248 nm causes amorphisation of the powder. The increase in amorphisation is determined by changes in the powder X-ray diffraction peaks before and after treatment. In order that the powder does not sinter together, it is subjected to ultrasonic agitation for the duration of exposure to the laser and the power of the laser is sufficiently low in the range 100-250 millijoules·cm⁻² not to cause ablation or sintering too. The powder is kept in argon gas throughout the experiment to avoid oxidation. The treated powder is collected and immersed into dodecene for 1 hour at 80° C. A comparison between this treated sample and a powder of untreated sample B subjected to the same immersion, confirmed greater organic functionalisation of the surface of the treated silicon sample, denoted by the ratio of the CHx stretching peaks around 2900 cm⁻¹ between the two samples. The explanation is that the increased amorphisation of the silicon and associated defect density allows reaction to occur between the silicon surface and organic molecules.

It should be appreciated that the processes, fine particles and dispersions of the invention are capable of being incorporated in the form of a variety of embodiments, only a few of which have been illustrated and described above. It will also be known to those skilled in the art that there are a number of combinations of methods and organic chemistries that may be exploited using these prescribed preparatory routes.

1. A process for the preparation of fine particles, the process comprising:
introducing a susceptor material into a plasma stream thereby vaporising some or all of the susceptor material;
cooling the susceptor material downstream from where the susceptor material was introduced, thereby creating particles of the susceptor material;
applying energy selected from electromagnetic radiation of wavelength shorter than the optical band gap of the susceptor material, sound waves, photons, or a combination thereof, to the particles; and
modifying the density of defects of the particles.

2. A process according to claim 1, wherein the susceptor material is selected from the group consisting of silicon; germanium; selenium; arsenic; antimony; tellurium; indium; gallium; aluminium; zinc; cadmium; lead; chalcogenides, phosphides or nitrides of the above; inorganic nano phosphors; quantum dots; and combinations thereof.

3. A process according to claim 1, wherein the susceptor material is silicon.

4. A process according to claim 1, wherein the susceptor material is cooled to a temperature in the range of 10-500° C.

5. A process according to claim 1, wherein the energy is selected from electromagnetic radiation of wavelength in the range of 1-2500 nm, ultrasound, laser light or combinations thereof.

6. A process according to claim 1, wherein the application of electromagnetic radiation heats only the surface of the particles.

7. A process according to claim 1, wherein the electromagnetic radiation is applied at one or more discreet wavelengths.

8. A process according to claim 1, wherein the modification of the surface of the particles occurs at a rate in the range of 0.1 seconds to 100 minutes.

9. A fine particle comprising:
a core comprising a susceptor material; and
a coating comprising functionality selected from hydrogen, methyl, ethyl or combinations thereof; and a C₆-C₂₄ alkyl.

10. A fine particle according to claim 9, of size in the range of 1-200 nm.

11. A fine particle according to claim 9, wherein the susceptor material is a high surface energy material.

12. A fine particle according to claim 9, wherein the coating substantially covers the core.

13. A dispersion comprising a dispersed phase and a continuous phase, wherein the dispersed phase comprises a multiplicity of fine particles according to claim 9.

14-16. (canceled)
